(19) United States
(12) Patent Application Publication
(10) Pub. No.: US 2007/0280634 A1
(43) Pub. Date: Dec. 6, 2007

(54) Recording/reproduction apparatus and method

(76) Inventor: Nobuhiro Kato, Akishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/785,698

(22) Filed: Apr. 19, 2007

(30) Foreign Application Priority Data
Apr. 28, 2006 (JP) 2006-126419

(51) Int. Cl. H04N 5/91

(52) U.S. Cl. 386/68; 386/E05.003

(57) ABSTRACT

According to one embodiment, an IFO generator records a storage position of I and P pictures recorded on a recording medium as an IFO file. An IFO analyzer selects a picture to be displayed corresponding to a reproduction speed in fast-forward reproduction from I, P and B pictures. The IFO analyzer analyzes the IFO file to determine a storage position of a picture required for decoding the selected picture. A picture stored in the storage position determined by the IFO analysis is read from the recording medium via a reader. Pictures are successively decoded via a decoder, and a picture to be displayed in pictures is displayed.

### CROSS-REFERENCE TO RELATED APPLICATIONS

This application is based upon and claims the benefit of priority from Japanese Patent Application No. 2006-126419, filed Apr. 28, 2006, the entire contents of which are incorporated herein by reference.

### BACKGROUND

1. Field

One embodiment of the invention relates to an apparatus for recording/reproduction a compressed video data stream. In particular, the present invention relates to a technique of fast-forwarding and reproducing a recorded video data stream.

2. Description of the Related Art

Jpn. Pat. Appln. KOKAI Publication No. 2002-197807 discloses the technique of fast-forwarding and reproducing a stream compressed and recorded in the MPEG format. According to the technique disclosed in the Publication, time map information is conventionally recorded. The time map information shows one picture storage position of a stream when the stream is stored in a recording medium. In fast-forward reproduction, all streams are decoded to perform high-speed reproduction, or one picture only is decoded and reproduced.

According to the conventional fast-forward reproduction, the following problem arises. Specifically, all streams are read and decoded. In this case, considering the maximum processing speed of a reproducer, it is general that 1.5×-speed fast-forward reproduction is given at the most. Moreover, one picture only is decoded and reproduced. In this case, the motion of a displayed video becomes discontinuous; for this reason, the video is not smoothly fast-forwarded and reproduced.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is a block diagram showing the stream recording configuration of a recording/reproduction apparatus according to one embodiment of the present invention;

FIG. 1B is a block diagram showing the stream reproduction configuration of a recording/reproduction apparatus according to one embodiment of the present invention;

FIG. 2 is a view showing a picture array;

FIG. 3 is a view to explain a fast-forward reproduction method according to one embodiment of the present invention;

FIG. 4 is a view showing the data structure required for specifying a storage position of a reference group; and

FIG. 5 is a flowchart to explain a fast-forward reproduction procedure of the present invention.

### DETAILED DESCRIPTION

Various embodiments according to the invention will be described hereinafter with reference to the accompanying,drawings. In general, according to one embodiment of the invention, there is provided a recording/reproduction apparatus comprising: a writer which write a stream compressed in an MPEG format in a recording medium while detecting I and P pictures of the stream, and specifies a storage position of the I and P pictures in the recording medium; a storage position recorder which records the storage position of the I and P pictures specified by the writer as a storage position file; an analyzer which selects a picture to be displayed corresponding to a designated reproduction speed from I, P and B pictures in fast-forward reproduction, and determines a storage position of picture required for decoding the selected picture by analyzing the storage position file; a reader which reads the picture stored in the storage position determined by the analyzer from the recording medium; and a decoder which successively decodes pictures read by the reader to output a picture to be displayed.

According to one embodiment of the present invention, smooth fast-forward reproduction is realized in the motion of video to decode or display a proper picture in accordance with a reproduction speed of fast-forward reproduction.

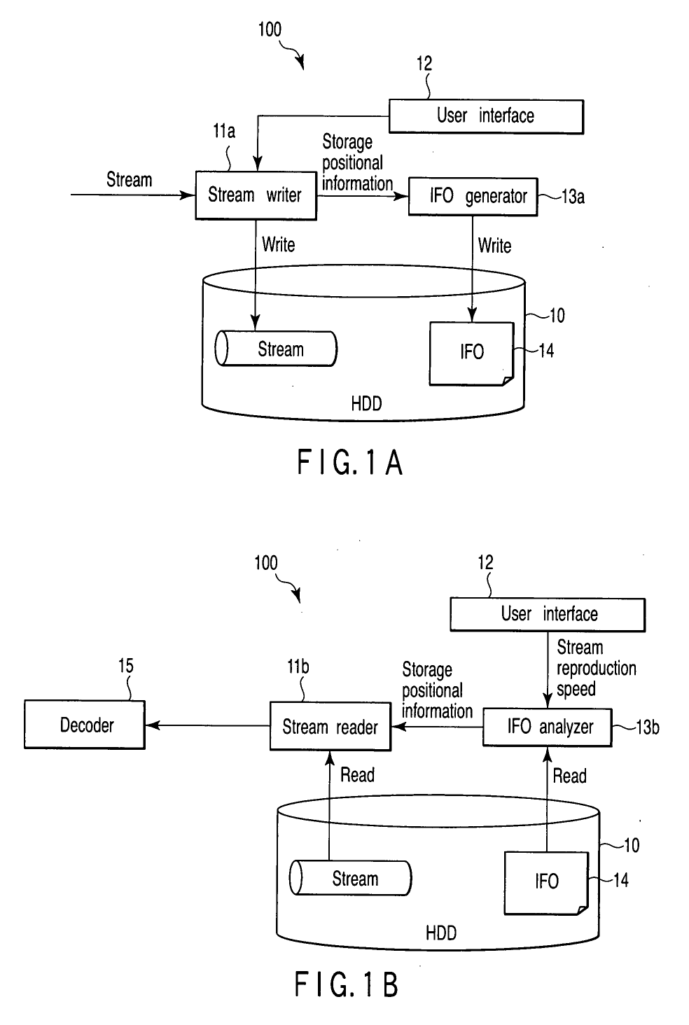

FIG. 1A and FIG. 1B show the configuration of a recording/reproduction apparatus 100 according to one embodiment of the present invention. For simplification of the explanation, there are shown a stream recording configuration (FIG. 1A) and a stream reproduction configuration (FIG. 1B). The recording/reproduction apparatus 100 is applicable as a video recorder/reproducer to DVD recorder, built-in HDD TV or PC.

The stream recording operation of each step will be hereinafter described with reference to FIG. 1A. A stream writer 11a writes a stream (program stream or transport stream) in a recoding medium 10 such as an HDD. During writing, the stream writer 11a detects an I picture or P picture of the stream to specify a stream storage position. An IFO generator 13a records a time map showing the storage position of the I or P picture specified by the stream writer 11a as an IFO file 14 (described later).

The stream reproduction operation of each step will be hereinafter described with reference to FIG. 1B. An IFO analyzer 13b calculates a picture number (described later) of the picture to be displayed next based on stream and reproduction speed designated by user. Moreover, the IFO analyzer 13b analyzes the IFO file to specify a picture storage position required for decoding the picture corresponding to the calculated picture number.

A stream reader 11b reads a picture stored in the specified storage position. A decoder 15 successively decodes the read stream and outputs a picture to be displayed. The picture output from the decoder 15 is displayed on a display device (not shown) such as an LCD or plasma display via a digital-to-analog converter and video amplifier.

The foregoing stream writer 11a, stream reader 11b, IFO generator 13a, IFO analyzer 13b and decoder 15 may be configured as software comprising program steps. Or the foregoing components may be configured as hardware using independent electronic circuits.

The stream handled according to one embodiment of the present invention will be described below. The stream input to the stream writer is as follows. For example, the stream is obtained by digitizing an analog video signal and compressing the digital data. Moreover, the stream is a compressed stream obtained by receiving a digital broadcast. The stream is a program stream compressed based on MPEG2 standard, for example. In the MPEG2, three pictures, that is, I, P and B pictures are given.

The foregoing I picture itself is independently decodable. In contrast, the P and B pictures are decoded in the following manner. The P picture is decoded referring to the decoded result of a reference picture (I or P picture) recorded before one in the recording sequence recorded in the recording medium. The B picture is decoded referring to the decoded result of reference pictures recorded before one and two in the recording sequence.

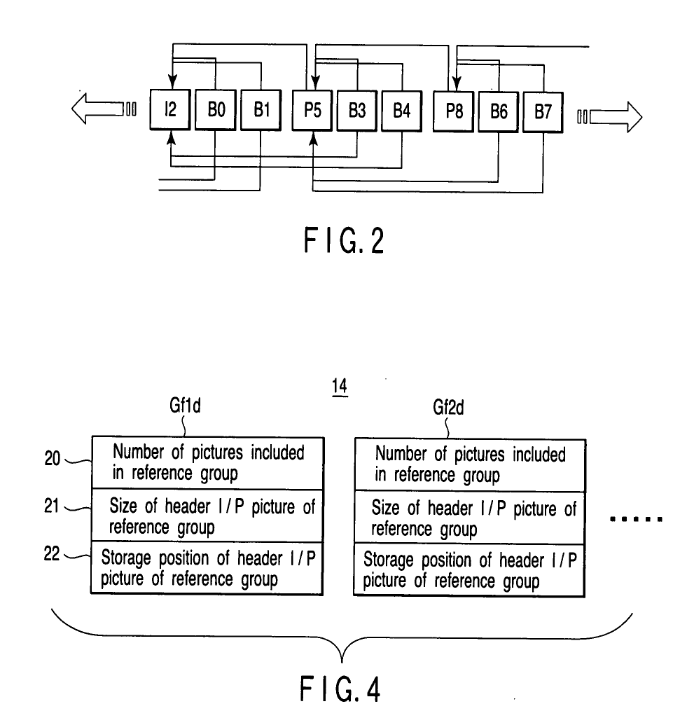

FIG. 2 is a view showing a picture array. For example, I2 is an I picture, and third reproduced picture in FIG. 2. B0 is a B picture, and first reproduced picture in FIG. 2. In FIG. 2, the picture giving an arrow is decoded referring to decoded result of the arrowed picture.

Considering the foregoing reference relationship, the recording sequence does not always correspond to the reproduction sequence. The reference picture (e.g., I2) before two referred by one B picture (e.g., B4) is prior to the B picture in the reproduction sequence. The reference picture (e.g., P5) before one is next to the B picture in the reproduction sequence.

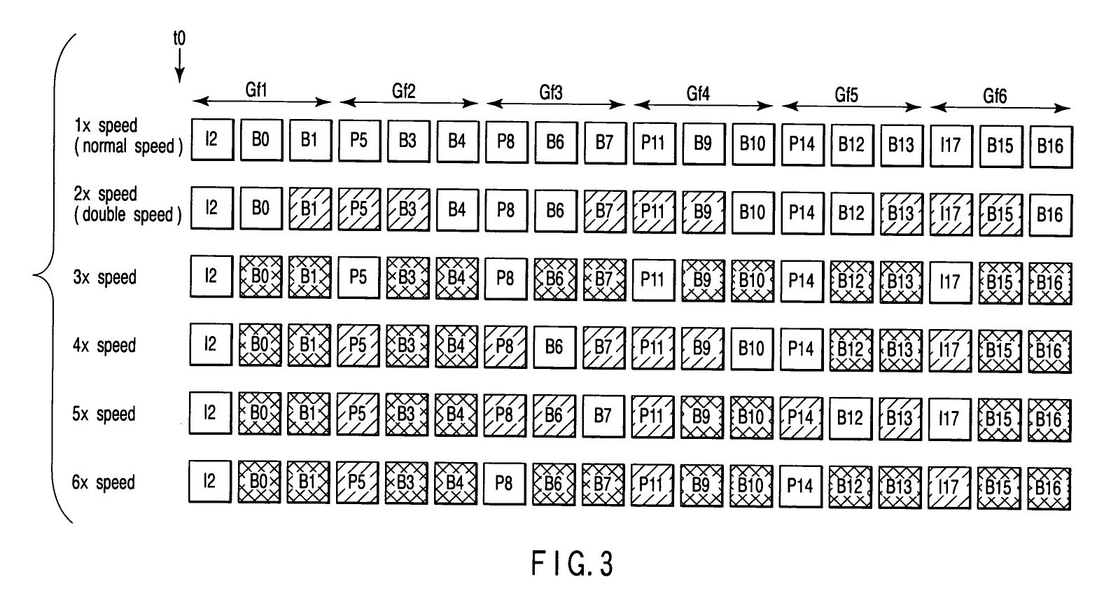

FIG. 3 is a view showing a fast-forward reproduction method according to one embodiment of the present invention. Specifically, FIG. 3 shows a state that display picture, read (decode) picture and skip picture in each reproduction speed are sequentially stored in a recording medium. The picture display sequence is expressed using a numeral.

In FIG. 3, a white picture shows a displayed picture. A white and hatched picture shows a picture which is decoded after being read from the HDD. A cross-hatched picture shows a picture such that reading from the HDD and decoding are skipped. As seen from FIG. 3, I and P pictures are basically decoded after being read from the HDD.

In the decoding sequence, if two B pictures existing between I and P pictures or between two P pictures need not be displayed, reading of these B pictures may be skipped. In other words, there is no need to read these B pictures.

An I or P picture and the next two B pictures are set as one group (calling reference group). In this case, a reproduction speed (3× speed) corresponding to the number of pictures (3 pictures in FIG. 3) included in the reference group or integer multiple speed (speed that is an integer multiple of 3) is given. Namely, when reproduction is carried out using 3× speed, 6× speed . . . , fast-forward reproduction is effectively realized. Specifically, the foregoing reproduction speed is given, the following advantage is given as compared with other fast-speed reproduction. As seen from the hatched picture, although the picture is decoded, it is not displayed. Therefore, the ratio of the number of pictures which are not displayed is low.

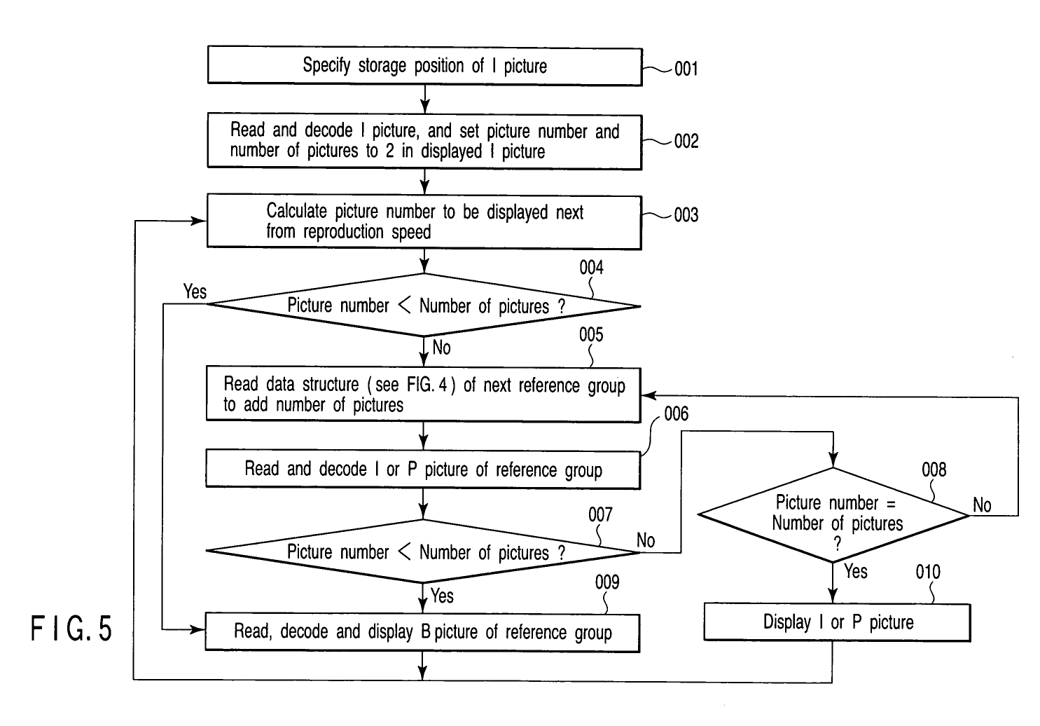

FIG. 4 shows the data structure required for specifying a storage position of the reference group. The data structure shown in FIG. 4 is held corresponding to each reference group.

The data structure includes the following data 20 to 22. The data 20 is the number of pictures (3 in this embodiment) included in the reference group. The data 21 is the size (bytes) of a header (leading) I or P picture of the reference group. The data 22 is a storage position of the header (leading) I or P picture of the reference group.

The data structure Gf1d shown in FIG. 4 shows the data structure of a reference group Gf1 including pictures I2, B0 and B1 shown in FIG. 3. The IFO file 14 shown in FIG. 1A and FIG. 1B includes the stream recorded in the recording medium, for example, data structures Gf1d, Gf2d, Gf3d . . . of all reference groups Gf1, Gf2, Gf3 . . . .

The fast-forward reproduction operation of the recording/reproduction apparatus of the present invention will be detailedly explained below.

When receiving fast-forward instructions from user, the apparatus successively determines a picture to be displayed in accordance with the instructed fast-forward reproduction speed (integer multiple of normal reproduction speed) using an I picture as a base point. When a picture number to be displayed next is determined, the apparatus finds a reference group including the picture number to display the picture. Here, the picture number is a numerical value showing the decoding (display) sequence of each picture in normal-speed reproduction. For example, “2” of I picture I2 shown in FIG. 3 is given as the picture number. Moreover, “0” of B picture B0 is given as the same as above.

In the reference group including no picture to be displayed, an I or P picture only is decoded after being read. If the picture to be displayed is an I or P picture, data of the reference group including the B picture are all read, and the B picture is decoded and displayed. If there is no need to display any B pictures included in the reference group, reading of these B pictures is skipped.

For example, according to the case of double-speed reproduction shown in FIG. 3, picture numbers, 0, 2, 4, 6, 8, 10, 12, 14, 16, 18 . . . , that is, pictures B0, I2, B4, B6, P8, B10, B12, P14, B16 . . . are displayed. The hatched pictures are only decoded, and not displayed, as described above. For example, the picture B1 is a picture decoded for confirming a data area of the picture B0.

Moreover, according to the case of 3×-speed reproduction, picture numbers 2, 5, 8, 11, 14, 17 . . . , that is, pictures I2, P5, P8, P1, P14, P17 . . . are displayed. In this case, B pictures need not be displayed; therefore, they are all skipped. The foregoing skip is generated when the fast-forward reproduction speed is a multiple of 3.

Hereinafter, 4×-speed reproduction, 5×-speed reproduction and 6×-speed reproduction are carried out in the manner described above. Incidentally, the IFO analyzer 13b determines pictures to be displayed and decoded based on user's instructions input from a user interface 12.

According to fast-forward reproduction according to one embodiment of the present invention, the display sequence of each picture, that is, the picture number, is given. The reproduction speed is set to N times (N=1, 2, 3 . . . ) as much as normal reproduction speed in fast-forward reproduction. By doing so, the IFO analyzer 13b determines the picture number of the picture to be displayed. In this case, the picture number is obtained by successively adding the foregoing N to the picture number (2 in FIG. 3) of I picture.

The reproduction speed of fast-forward reproduction is N times as much as normal reproduction speed, and N is a multiple of 3. In this case, the IFO analyzer 13b selects the storage position of I and P pictures only as the storage position of the picture required for decoding the picture to be displayed. Then, the IFO analyzer 13b skips the storage positions of the B pictures.

FIG. 5 is a flowchart to explain the fast-forward reproduction procedure of the present invention. Here, in the picture sequence of each reproduction speed shown in FIG. 3, 3×-speed reproduction instructions are input to the IFO analyzer 13b via the user interface 12 at time t0.

The IFO analyzer 13b specifies the storage position of the I picture (I2 in FIG. 3) closest to the current time t0 (step 001). The stream reader 11b reads I picture I2, and the read I picture I2 is decoded by the decoder 15 and displayed on a display device (not shown) (step 002). Here, the IFO analyzer 13b sets a picture number Pm of the I picture to the initial value (2 herein) while setting the number of pictures Pn to the initial value (2 same as the picture number).

The IFO analyzer 13b calculates a picture number of a picture to be displayed next from the instructed reproduction speed (step 003). In this case, user gives 3×-speed reproduction instructions. Therefore, the picture number of a picture to be displayed next is 5 by adding 3 of 3× speed to the picture number 2 set in step 002.

As seen from step 004, the IFO analyzer 13b determines whether or not the picture number Pm is smaller than the number of pictures Pn. In this case, the picture number Pm is 5, and the number of pictures Pn is 2; therefore, the flow proceeds to step 005.

In step 005, the data structure Gf2d (see FIG. 4) of the next reference group (Gf2 herein). Then, the number of pictures (3 in this embodiment) of the reference group is added to the number of pictures Pn. As a result, the number of pictures Pn becomes 5 in this embodiment.

In step 006, the I or P picture described in the data structure read in step 005 is read from the recording medium 10 and decoded. In this embodiment, P picture P5 of the reference group Gf2 is read and decoded. In this case, the storage position of the I or P picture of the reference group is determined from the storage position 22 (see FIG. 4) of the header I/P picture of the reference group.

In step 007, it is determined whether or not the picture number Pm is smaller than the number of pictures Pn. In this case, the picture number Pm is 5, and the number of pictures Pn is 5. Therefore, the flow proceeds to step 008. In step 008, it is determined whether or not the picture number Pm is equal to the number of pictures Pn. In this case, the picture number Pm is equal to the number of pictures Pn as seen from the foregoing description. Therefore, the flow proceeds to step 010.

In step 010, the decoder 15 outputs the I or P picture decoded in step 006, and then, the P picture is displayed. In this case, P picture P5 of the reference group Gf2 is displayed.

The flow proceeds to step 003, and then, the IFO analyzer 13b calculates the picture number Pm to be displayed next from the instructed reproduction speed. In this case, the current picture number Pm is 5, and the reproduction speed is 3× speed. Therefore, the picture number Pm to be displayed next is 8 (=5 +3).

If the reproduction speed is 3× speed, the same procedure as described above is taken after that. In other words, the procedures of steps 003 to 008 and step 010 are repeatedly taken. I and P pictures only are displayed, and reading of B pictures is skipped.

Now, 5×-speed reproduction will be described as another fast-forward reproduction. Steps 001 and 002 involve the same procedures as for the foregoing 3×-speed reproduction.

The IFO analyzer 13b calculates a picture number to be displayed next from the instructed reproduction speed (step 003). The picture number Pm to be displayed next becomes 7 by adding 5 of 5× speed to the picture number 2 set in step 002.

In step 004, the IFO analyzer 13b determines whether or not the picture number Pm is smaller than the number of pictures Pn. In this case, the picture number Pm is 7, and the number of pictures Pn is 2; therefore, the flow proceeds to step 005.

In step 005, the data structure (see FIG. 4) of the next reference group (Gf2 herein) is read to add the number of pictures (3 in this embodiment) of the reference group to the picture number Pn. As a result, the picture number Pn becomes 5 in this embodiment.

In step 006, the I or P picture of the reference group read in step 005 is read and decoded. In this embodiment, P picture P5 of the reference group Gf2 is read and decoded. In this case, the storage position of the I or P picture of the reference group is determined from the storage position 22 (see FIG. 4) of the header I/P picture of the reference group.

In step 007, it is determined that the picture number Pm is smaller than the number of pictures Pn. In this case, the picture number Pm is 7, and the number of pictures Pn is 5; therefore, the flow proceeds to step 008.

In step 008, it is determined whether or not the picture number Pm is equal to the number of pictures Pn. In this embodiment, the picture number Pm is different from the number of pictures Pn as described above; therefore, the flow proceeds to step 005.

In step 005, the data structure (see FIG. 4) of the next reference group (Gf3 herein) is read to add the number of pictures (3 in this embodiment) of the reference group to the picture number Pn. As a result, the picture number is 8 in this embodiment.

In step 006, the I or P picture of the reference group read in step 005 is read and decoded. In this embodiment, P picture P8 of Gf3 is read and decoded.

In step 007, it is determined whether or not the picture number Pm is smaller than the number of pictures Pn. In this case, the picture number is 7, and the number of pictures Pn is 8; therefore, the flow proceeds to step 009.

In step 009, the B picture of the reference group is read and decoded to display the picture. In this embodiment, the decoder reads and decodes B pictures B6 and B7 of the reference group Gf3, and outputs B picture B7 to display the B picture B7. The storage position of the B picture B7 is found by decoding B picture B6. The storage position of the B picture B6 is determined from the size 21 of the header I/P picture of the reference group of the data structure Gf3d specifying the reference group Gf3.

Then, the flow proceeds to step 003, and the IFO analyzer 13b calculates a picture number to be displayed next from a reproduction speed. In this embodiment, the picture number Pm to be displayed next becomes 12 by adding 5 of 5× speed to 7 of B picture B7 displayed in step 009. Likewise, pictures having picture numbers 12, 17, 22 . . . are displayed.

If the reproduction speed is larger than 6× speed, the following case is given. Specifically, the picture number to be reproduced next exceeds the next I picture, and there exists one or more P picture reference groups between them. In such a case, decoding of P pictures of these reference groups is skipped.

As described above, according to one embodiment of the present invention, picture is properly decoded and displayed in accordance with fast-forward reproduction speed. Therefore, smooth fast-forward reproduction is realized in video motion. Moreover, in picture decoding, the minimum necessary stream is read. Therefore, as compared with the case of reading all streams, read load on the stream reader 11b is reduced.

While certain embodiments of the inventions have been described, these embodiments have been presented by way of example only, and are not intended to limit the scope of the invention. Indeed, the novel methods and systems described herein may be embodied in a variety of other forms; furthermore, various omissions, substitutions and and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording/reproduction apparatus comprising:
a writer which write a stream compressed in an MPEG format in a recording medium while detecting I and P pictures of the stream, and specifies a storage position of the I and P pictures in the recording medium;
a storage position recorder which records the storage position of the I and P pictures specified by the writer as a storage position file;
an analyzer which selects a picture to be displayed corresponding to a designated reproduction speed from I, P and B pictures in fast-forward reproduction, and determines a storage position of picture required for decoding the selected picture by analyzing the storage position file;
a reader which reads the picture stored in the storage position determined by the analyzer from the recording medium; and
a decoder which successively decodes pictures read by the reader to output a picture to be displayed.

2. The apparatus according to claim 1, wherein when a display sequence of each picture is set as a picture number and a reproduction speed in the fast-forward reproduction is set as N (N=1, 2, 3 . . . ) times as much as normal reproduction speed, the analyzer obtains a picture number of the picture to be displayed by successively adding the N to the picture number of I picture.

3. The apparatus according to claim 1, wherein when the reproduction speed in the fast-forward reproduction is N (N=1, 2, 3 . . . ) times as much as normal reproduction speed, and the N is equal to one of an interval and a multiple of the interval between the I and P pictures, the analyzer skips the storage position of the B picture as a storage position of the picture required for decoding the picture to be displayed.

4. The apparatus according to claim 1, wherein the storage position recorder records a size of the I and P pictures, and the analyzer determines a storage position of B picture from the storage position and size of one of the I and P pictures.

5. A recording/reproduction method comprising:
writing a stream compressed in an MPEG format in a recording medium while detecting I and P pictures of the stream, and specifying a storage position of the I and P pictures in the recording medium;
recording the storage position of the specified I and P pictures as a storage position file;
selecting a picture to be displayed corresponding to a designated reproduction speed from I, P and B pictures in fast-forward reproduction, and determining a storage position of picture required for decoding the selected picture by analyzing the storage position file;
reading the picture stored in the determined storage position from the recording medium; and
successively decoding the read pictures to output a picture to be displayed.

6. The method according to claim 5, wherein when a display sequence of each picture is set as a picture number and a reproduction speed in the fast-forward reproduction is set as N (N=1, 2, 3 . . . ) times as much as normal reproduction speed, according to the analysis of the storage position file, a picture number of the picture to be displayed is obtained by successively adding the N to the picture number of I picture.

7. The method according to claim 5, wherein when the reproduction speed in the fast-forward reproduction is N (N=1, 2, 3 . . . ) times as much as normal reproduction speed, and the N is a multiple of 3, according to the analysis of the storage position file, a storage position of B picture is skipped as a storage position of picture required for decoding the picture to be displayed.

8. The method according to claim 5, wherein according to recording of the storage position, a size of the I and P pictures is recorded, and according to the analysis of the storage position, a storage position of B picture is determined from the storage position and size of one of the I and P pictures.
